(19) United States
(12) Patent Application Publication
(10) Pub. No.: US 2004/0259561 A1
(43) Pub. Date: Dec. 23, 2004

(54) Apparatus and method for improved trunking efficiency in networks having enhanced terminals

(76) Inventors: Kenneth A. Stewart, Grayslake, IL (US); Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/461,833

(22) Filed: Jun. 13, 2003

(51) Int. Cl. H04Q 7/20

(52) U.S. Cl. 455/452.2; 455/426.1

(57) ABSTRACT

The embodiments of the present invention provide a method and apparatus for assigning enhanced mobile subscriber units to a telecommunications network. In a first embodiment, a network identifies a classmark of a mobile subscriber unit and determines whether the mobile has an enhanced performance capability, for example an interference cancellation capability. If the mobile is enhanced, it is assigned to a high fractional load timeslot. If not, a low fractional load timeslot is allocated. Handover procedures are controlled in a like manner, wherein mobile capability is determined prior to assigning timeslots during handover.

### FIELD OF THE INVENTION

The present invention relates generally to digital cellular telecommunications networks, and more particularly, to a TDMA telecommunications network having enhanced mobile subscriber units.

### BACKGROUND OF THE INVENTION

Network operators face a number of issues when deploying enhanced mobile stations in networks where subscribers still own and operate older generation, conventional mobile stations. One such problem occurs for deployment of mobile stations with improved receiver performance, for example mobiles having interference cancellation capability. Because of the different characteristics of newer and older mobiles, maintaining an acceptable carrier to interference (C/I) ratio on the forward link becomes a problem in networks having a mix of both mobile types.

A first possible solution to this problem is to assign conventional users to frequencies within the system radio coverage areas where the distribution of signal-noise ratio, or carrier-interference ratio is higher. For example, in GSM (Global System for Mobile communications) networks, channels not subject to frequency hopping may be used. For example, the Broadcast Control Channel (BCCH) or ‘c0’ frequency layer can be employed, in which for example a 4×3×12 (4 sites, 3 sectors, 12 carrier frequency groups) BCCH frequency reuse pattern is applied.

A second network layer that employs frequency hopping, the frequency hopping (FH) layer, would be used as the target system frequency layer for interference-suppression capable mobile stations. When interference-suppression capable mobile stations are so assigned, the frequency-hopping layer can be designed to have a higher fractional load (i.e. a higher probability that each carrier frequency in the carrier assigned to the FH layer is actually in use at any particular time) and still achieve acceptable C/I levels because of the superior mobile station capability.

However, such a solution would have a problem of trunking efficiency, because conventional mobiles would be forced into the BCCH layer and interference canceling mobile stations would be forced into the frequency-hopping layer. Accordingly, neither class of mobile station would be able to access all of the frequency resources in the system.

A second possible solution is to assign conventional mobiles to the frequency-hopping layer initially. As the time-fractional loading increased, the conventional mobile communication would degrade because such mobiles would be reliant solely upon the fractional loading for interference control. The conventional mobile stations could then be handed over to the BCCH layer to maintain an acceptable C/I characteristic. However, the end result is still a hard division of mobile stations between the BCCH and frequency-hopping layers, which leads again to trunking inefficiency.

In general, neither of the above-described solutions provides flexibility for optimizing radio spectrum resources, as new generation terminals are increasingly deployed on the network.

Thus a need exists for an apparatus and method for allocating mobile stations having differing interference rejection characteristics, into a network frequency-hopping layer simultaneously.

### BRIEF DESCRIPTION OF THE DRAWINGS

FIG. 1 is a block diagram of a network in accordance with some embodiments of the present invention.

FIG. 2 is a table illustrating a frequency allocation for a 4×12 frequency plan.

FIG. 3 is a diagram illustrating a network cell layout in accordance with a 4×12 frequency allocation.

FIG. 4. is a table illustrating a frequency allocation with layers having a BCCH layer and a frequency hopping layer.

FIG. 5 is a diagram of hopping sequences and corresponding hopping sequence numbers that may be assigned to cell sectors.

FIG. 6 is a diagram illustrating timeslot allocation in accordance with some embodiments of the present invention.

FIG. 7 is a diagram illustrating timeslot fractional loading in accordance with some embodiments of the present invention.

FIG. 8 is a flow diagram of a network operation in accordance with some embodiments of the present invention.

FIG. 9 is a flow diagram of a network operation in accordance with some embodiments of the present invention.

FIG. 10 is a flow diagram of a network operation with respect to handovers in accordance with some embodiments of the present invention.

### DETAILED DESCRIPTION OF THE PREFERRED EMBODIMENTS

A method and apparatus for assigning mobile terminals with enhanced performance to communication timeslots are provided herein. In some embodiments of the present invention, a first group of mobile terminals in communication with a TDMA network, for example a GSM network, via a base transceiver station (BTS) may have an enhanced performance over a second group of conventional mobiles. For example, the enhanced group of mobiles may have an interference cancellation capability, for example a Single Antenna Interference Cancellation (SAIC) capability.

In a first embodiment of the present invention, a network uses a mobile terminal's classmark to determine whether the mobile terminal has interference cancellation capability. In a second embodiment of the present invention, mobile station performance may be inferred from the mobile station characteristics. For example, power allocation by a base station to a mobile station may be observed during call setup and channel assignment procedures. In a third embodiment, the mobile station performance may be contained in a database such as a Home Location Register (HLR) database and retrieved during an access procedure of the network.

If the mobile station has enhanced performance capability such as interference cancellation capability, then the mobile station is assigned to a high-fractional load timeslot. Conversely, if the mobile station does not have interference cancellation capability, such that the mobile station is of a previous generation, then the mobile station is assigned to a low fractional load timeslot.

In some embodiments of the present invention, handovers are handled in a similar manner. The network measures a link quality parameter for a mobile station, for example an estimated bit error rate (BER, or equivalently an ‘RXQUAL’ measurement in a GSM network) or an estimated receive power level (‘RXLEV’ in a GSM network) in accordance with network handover routines. If the network determines that a handover is required, for example in some embodiments when a measured parameter, or combination of parameters, is greater than a set threshold, then the network determines whether the mobile station supports interference cancellation. If the mobile supports interference cancellation, then it is handed over to an alternative high fractional load timeslot. Similar for the initial assignment case, if the mobile station does not support interference cancellation, and is therefore an older generation mobile station, it is assigned to a low fractional load timeslot.

A first aspect of the present invention is a communications network comprising at least one base station suitable for assigning a mobile station to a timeslot depending upon a performance characteristic of the mobile station.

A second aspect of the present invention is a telecommunications network having a frequency hopping radio coverage layer with timeslots configurable for various fractional loads. In this aspect, mobiles with enhanced performance capabilities may be assigned to the hopping layer along with mobiles of previous generation capabilities. Assigning the mobile station to a timeslot with an appropriate fractional load controls the interference levels experienced by the mobile station.

A third aspect of the present invention is a base transceiver station configurable to support a pseudo-random frequency hopping radio network with timeslots configurable for various fractional loads. The base transceiver station also supports handover of mobile stations based on mobile station capability to a timeslot with an appropriate fractional load.

A fourth aspect of the present invention is a radio transceiver unit, configurable to support frequency hopping and configuration of timeslots with various fractional loads.

A fifth aspect of the present invention is a method of timeslot assignments for a mobile station based upon the mobile station's performance capability.

A sixth aspect of the present invention is a method of timeslot assignment for a mobile station during handover also based upon the mobile station's performance capability.

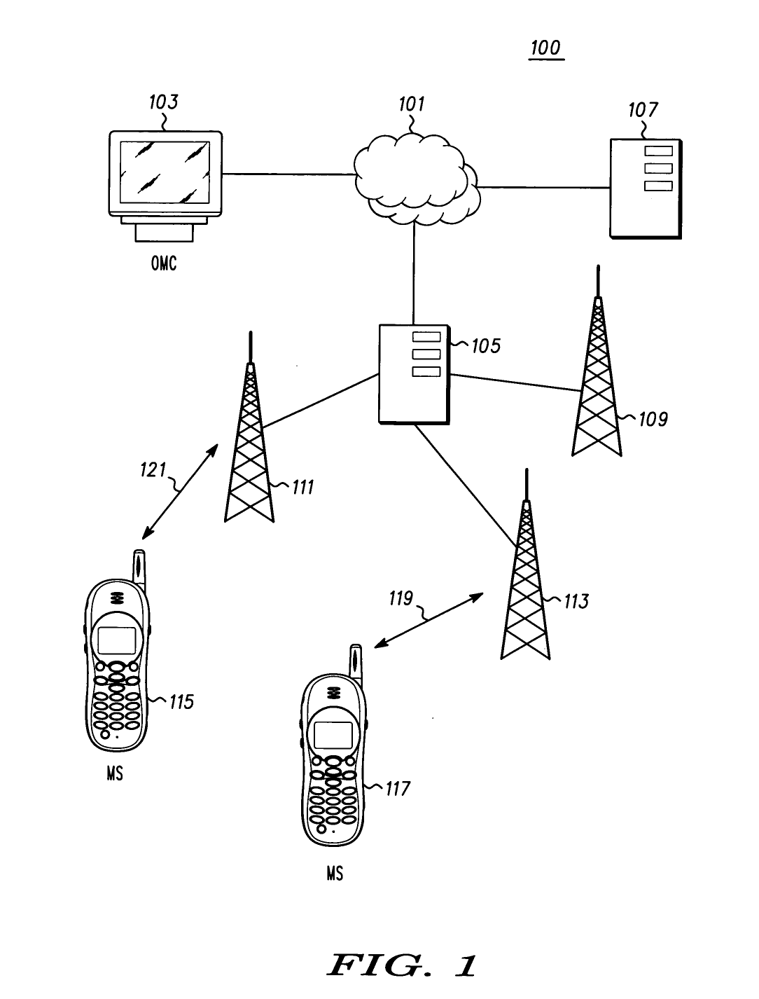

Turning now to the drawings where like numerals designate like components, FIG. 1 illustrates a typical network in accordance with some embodiments of the present invention. In FIG. 1, a network 100 comprises a plurality of Base Station Controllers (BSCs) 105, 107, each BSC connectively coupled to a network 101, in which the network 101 typically comprises a Mobile Switching System (MSC). Network 100 may comprise other network elements as represented by network 101 for example, an Operation and Maintenance Center (OMC) 103. Additionally, network 101 may support a packet-based protocol suitable for communication over the Internet.

Each BSC 105, 107 is further connectively coupled to a plurality of Base Transceiver Stations (BTS). For example BSC 105 is connectively coupled to BTS 109, 111, and 113. The plurality of BSCs and respective BTSs, for example BSC 105, together with BTS 109, 111, and 113, form a Radio Access Network (RAN).

Each BTS of the RAN is capable of establishing a two-way communication with a plurality of mobile stations (MS), via an air interface radio channel. For example, MS 115 communicates with BTS 111 via a channel 121, and MS 117 communicates with BTS 113 via a channel 119.

The radio carrier of channels 119 and 121 are time division multiple access (TDMA) radio carriers and are divided into a number of timeslots, for example eight timeslots as in the GSM RAN. Further, the radio carriers of channels 119 and 121 may be modulated using any number of techniques in accordance with embodiments of the present invention. For example, the network may utilize GMSK per the GSM standard, or may utilize 8PSK in accordance with the Enhanced Data Rates for GSM Evolution (EDGE) standard. Additionally, a number of timeslots of each cellular sector may be reserved for General Packet Radio Service (GPRS).

The MS 115 and MS 117 may be of various types. For example MS 117 may have an interference cancellation capability, for example, Single Antenna Interference Cancellation (SAIC) capability.

FIG. 2 is an example of a “4-by-12” (4×12) frequency grouping for use in frequency planning a TDMA network for example a GSM network. Although FIG. 2 shows 79 channels, this is for exemplary purposes only because in most cases the number of frequencies available to an operator will be limited to a smaller spectrum. FIG. 2 is arranged by rows, in which the number of rows will be limited to a network operator's available spectrum, and by 12 columns such that a column of frequencies is assignable to a BTS sector.

The assignment of frequencies to BTS cellular sectors in accordance with such a table helps to maintain minimum co-channel and minimum adjacent channel spacing during planning of the radio access network. The minimum channel spacing is required to minimize radio interference between the transceivers of neighboring cells and sectors. It is to be understood that the 4×12 frequency allocation illustrated by FIG. 2 is for exemplary purposes only and is not a limitation on the frequency allocation employed in embodiments of the present invention. For example, a “3×9” or other pattern could have been employed.

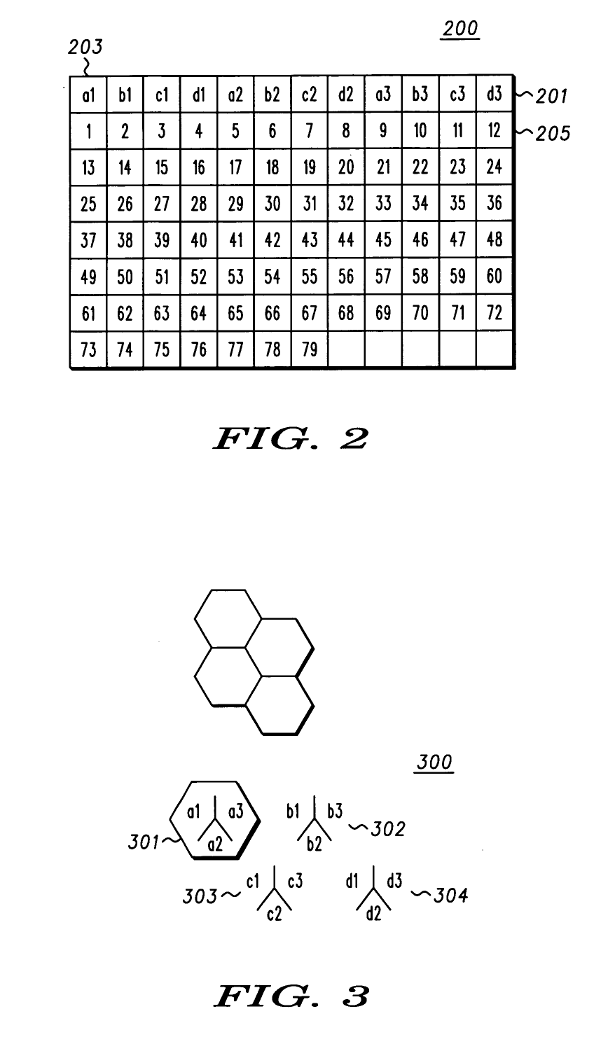

FIG. 2 is more readily understood with reference to FIG. 3, which illustrates a “4-by-12” (4×12) or “4-by-3” (4×3) frequency reuse pattern 300. In FIG. 3, 4 cells each having 3 sectors each are arranged in a pattern as shown. Thus the pattern of FIG. 3 is referred to as a 4×3. Alternatively, the pattern of FIG. 3 may be referred to as a 4×12 pattern based upon the 12 frequency columns allocated in the table 200 of FIG. 2. The basic pattern of FIG. 3 is repeated as required for the ultimate number of BTS cells in the radio access network.

Returning to FIG. 2 and recognizing that each column header 201 represents a number of frequencies in each respective column, it is to be noted that each sector shown in FIG. 3 may utilize a plurality of frequencies. For example, column “a1” corresponds to frequencies 1, 13, 25, 37, 49, 61 and 73. Therefore in FIG. 3, cell 301, sector a1, may comprise any frequencies from the table 200, column a1. It is to be understood that the frequency plan illustrated by FIG. 3 is for exemplary purposes only and that the frequency plan may be improved in realistic scenarios by taking into account effects such as inter-cell co-channel and adjacent channel interference and real-world propagation effects via computer simulation, field measurements, or a combination of techniques.

Cellular sites with multiple frequency assignments per sector are typically referred to in terms of the number of assigned frequencies. For example, cell 301 sector a1 may be assigned frequencies 1 and 13, a2 may be assigned frequencies 5 and 17, and a3 may be assigned frequencies 9 and 21. In this case, each sector has two frequencies. Therefore, cell 301 would be referred to as a “2-2-2” cell site. In GSM cell sites, one frequency must have a timeslot assigned as a Broadcast Control Channel (BCCH). The BCCH is observed by mobile stations and serves as a reference for mobile stations attempting to access the network.

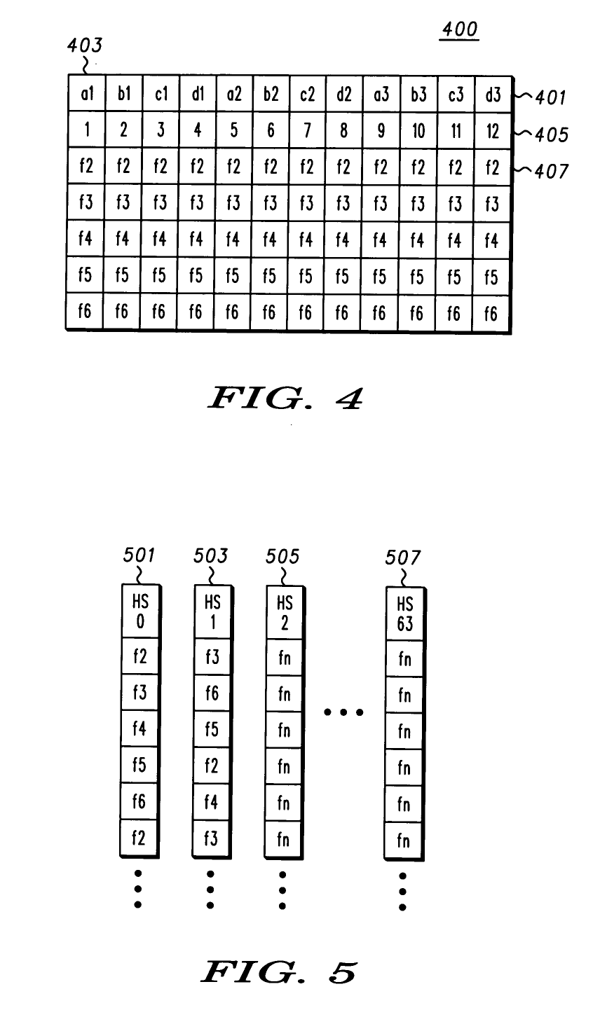

Frequency hopping is an alternative frequency reuse technique utilized in TDMA networks such as GSM networks. FIG. 4, table 400 illustrates conceptually the assignment of frequencies to cellular sectors employing a frequency-hopping schema. In FIG. 4, Table 400, each sector is assigned a frequency for use as a BCCH carrier. Because the BCCH carrier is a reference for an MS attempting to access the network it must remain static and cannot hop. Therefore, the BCCH frequencies can still be assigned to sectors using the 4×12 reuse pattern of FIG. 2. FIG. 4 duplicates the 4×12 pattern for the first row of frequencies 405, in which this first set would be assigned as BCCH carriers. Additional static carriers may likewise be assigned. Any static, non-hopping carriers are referred to as the “BCCH layer.”

In FIG. 4, row 407 and downward illustrates that a number of hopping frequencies may be utilized in each sector, in addition to the BCCH layer. These frequency assignments constitute the “hopping layer” of the network. In the hopping layer, every sector can be assigned the same set of frequencies. However, each sector is additionally assigned a hopping sequence number (HSN) such that close sectors follow different pseudo-random sequences.

FIG. 5 provides a simplified example of pseudo-random hopping sequences as used in GSM networks. A first hopping sequence, HS0 501 uses the frequency set essentially in order. A number of pseudo-random sequences, up to HS63 may be assigned to a sector. FIG. 5 HS1 503 indicates a sequence for exemplary purposes, that is different then HS0. Likewise, HS2 505 through HS63 507 would employ different sequences. The sequences are designed to be mathematically orthogonal such that they will theoretically avoid radio interference. Returning to FIG. 3, cell 301, sector a3 may be assigned HS2, while the potentially interfering cell 302, sector b1 may be assigned HS32.

A BTS typically comprises a number of transceiver units, each unit capable of being tuned to a given assigned carrier frequency. For example, a transceiver of cell 301, sector a1 may be assigned to frequency 1 and be the sector a1 BCCH carrier transceiver. Other transceiver units of the sector that are assigned to hopping carriers are also assigned a hopping sequence number (HSN), which determines a pseudo-random sequence in which the transceiver will hop as discussed above. Because the transceiver unit is able to “synthesize” and retune to the appropriate frequency within the required time interval, this technique is referred to as synthesizer frequency hopping. Synthesizer frequency hopping is to be distinguished from the base-band frequency hopping technique in which a transceiver unit remains tuned to a single frequency. Synthesizer frequency hopping is required in order to achieve the benefits of the embodiments of the present invention.

Further, the embodiments of the present invention utilize a synchronous network. In a synchronous network employing synthesizer frequency hopping the timeslots of all cell sectors have a common reference point. The common reference point enables the hopping sequences of each neighboring cell to avoid using the same, or adjacent frequencies, during the same time interval thereby reducing network interference levels. In frequency-hopping networks a fractional load, which is a mean usage of transmission frequency, is defined as the number of hopping transceivers divided by the number of hopping frequencies. Returning to FIG. 4 as an example, if sector al had a single transceiver hopping over 5 frequencies the fractional load would be ⅕.

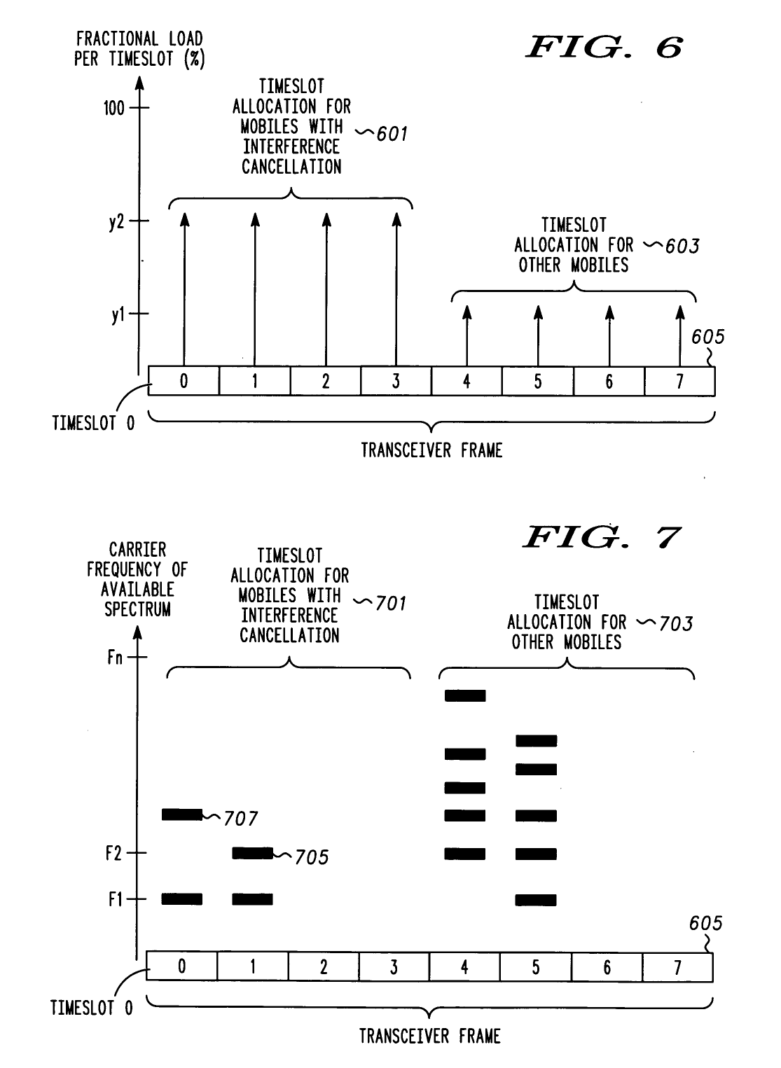

However, fractional load can also be allocated on a timeslot basis. In FIG. 6, a single carrier frequency, which is divided into eight timeslots, is shown as transceiver frame 605. In FIG. 6, each timeslot can have an independent fractional load. Therefore, a mobile station may be assigned to a timeslot, based upon the timeslot fractional load. FIG. 7 illustrates the transceiver frame 605 of FIG. 6, and exemplary fractional loading on a timeslot basis. In FIG. 7, the vertical axis represents discrete frequencies corresponding to the carrier frequencies available in a given network operator's spectrum. The horizontal bars of FIG. 7 represent hopping carriers assigned to individual timeslots. For example, in FIG. 7, timeslot 1 has two hopping carriers, one of which is frequency F2 705. Likewise, timeslot 0 has two hopping carriers, one of which is some frequency Fn 707. In FIG. 7, timeslots 4 and 5 have a larger number of active hopping carriers than timeslots 0 and 1. The fractional loading of timeslots 0 and 1 therefore, can be considered to have a higher fractional loading than timeslots 4 and 5. In accordance with the example of FIG. 7, the fractional loading of a timeslot can be considered as the ratio of active carriers to total available spectral carriers per timeslot.

Accordingly, a performance enhanced mobile station, for example a mobile station with an interference cancellation capability, could accommodate higher levels of fractional loading than a mobile station that relied solely on the fractional loading for interference reduction. In some embodiments of the present invention, this characteristic is utilized advantageously such that interference cancellation capable mobile stations and conventional mobile stations may utilize the frequency-hopping layer of a network simultaneously thereby reducing network carrier to interference levels (C/I) and improving the trunking efficiency of the network.

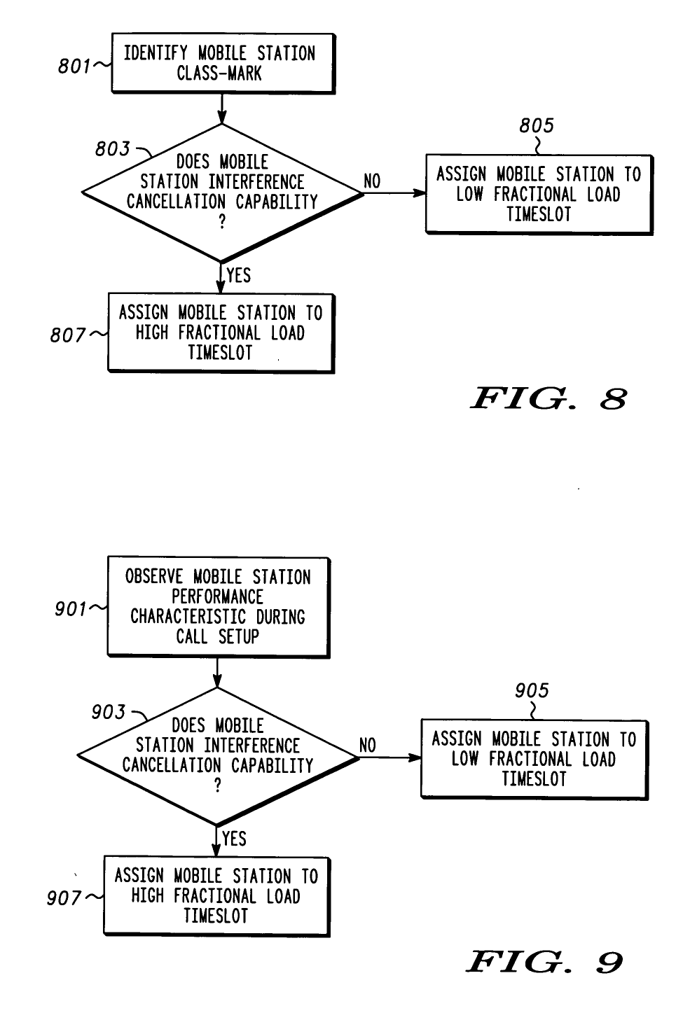

In FIG. 8, a network operation is illustrated in accordance with some embodiments of the present invention. In FIG. 8, a mobile station attempts to gain access to a network, for example when a user initiates call setup procedures. The network identifies the mobile station classmark in block 801. In block 803, the classmark is used to determine whether the mobile station supports interference cancellation. If the mobile station does not support interference cancellation, it is assigned to a timeslot with low fractional loading 805. The timeslot assignment enables the mobile station to take advantage of the generally higher C/I characteristics achieved by the lower fractional load.

If the mobile station supports interference cancellation, then it is assigned to a high fractional load timeslot in block 807. The combination of the high fractional load timeslot with the mobile station's interference cancellation characteristics enables the mobile station to achieve acceptable levels of performance.

In FIG. 9, a second embodiment is illustrated in which mobile station performance is observed in block 901. The observed mobile station performance may comprise a power level parameter such as RXLEV in a GSM network, or a quality metric such as an estimated bit error rate like RXQUAL in a GSM network, or some combination of such parameters or metrics. The observance may occur during initial channel assignment, or during an authentication interval for the network.

In block 903, the network determines the mobile capability and assigns the mobile station to a low fractional load timeslot 905 if the mobile does not support interference cancellation. If the mobile station does support interference cancellation, is assigned to a higher fractional load timeslot in block 907.

In a third embodiment of the present invention, the mobile station performance capability may be recorded in a database such as a Home Location Register (HLR) database and associated with a given hardware identifier or subscriber identifier. In this scenario, the mobile station capability would be determined during an authentication procedure of a mobile station and subscriber. The network may maintain an initial channel assignment or reassign the authenticated mobile as required.

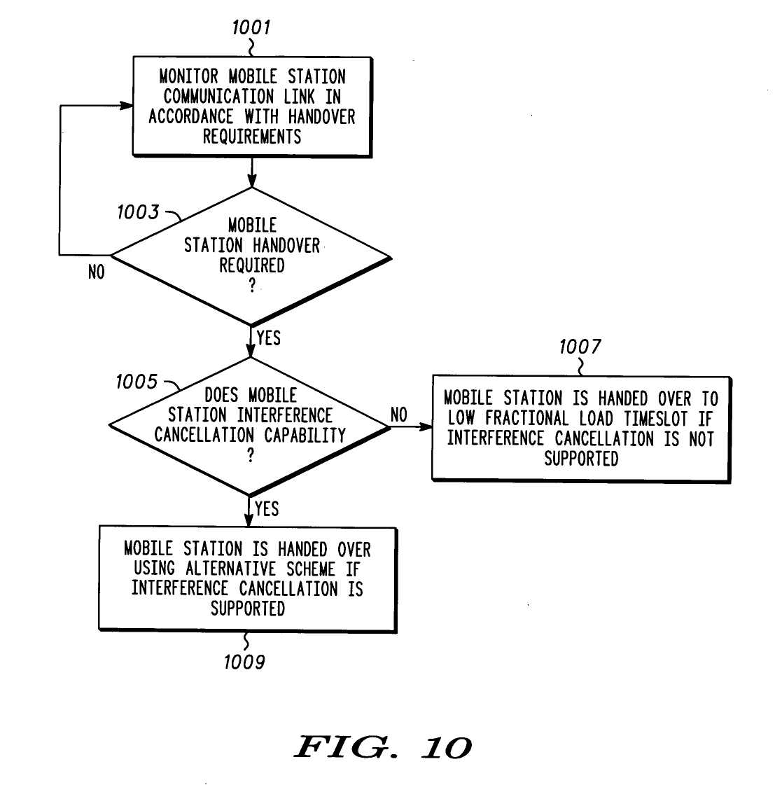

In FIG. 10, a handover operation of a network in accordance with some embodiments of the present invention is illustrated. In block 1001, a communication link between a mobile station and a network is measured in accordance with the requirements of handover operations. For example a bit error rate (BER), which corresponds to the RXQUAL parameter of a GSM network may be monitored. If for example the RXQUAL value increases, an increase in BER is indicated corresponding to a lower link quality. In some embodiments, a network threshold is set such that when the measured link quality parameter crosses the threshold, and remains above it for a predetermined period of time, a handover procedure is initiated. According to such a scheme, or other schemes appropriate for determining whether a handover is required, the network makes a determination in block 1003. If a handover is not required, the network continues to monitor the link as in block 1001. If the network determines that a handover is required, then the network determines whether the mobile station supports interference cancellation in block 1005.

If the mobile station does not support interference cancellation, it is assigned to a low fractional load timeslot as illustrated in block 1007. If the mobile station supports interference cancellation, then an appropriate handover scheme is applied as illustrated in block 1009. The scheme will assign the mobile station to a high fractional load timeslot based on the mobile station capability and other network criteria.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A telecommunications network comprising:
at least one base station, suitable for assigning a mobile station to a radio resource in a partitioned radio network depending upon a performance characteristic of the mobile station.

2. The telecommunications network of claim 1, wherein the radio resource is a timeslot.

3. The telecommunications network of claim 1, wherein the performance characteristic is an interference cancellation capability.

4. The telecommunications network of claim 3, wherein the interference cancellation capability is a single antenna interference cancellation capability.

5. A telecommunications network having a frequency hopping radio coverage layer with timeslots having a plurality of fractional loads, the network comprising:
a first group of mobile stations with a first performance capability and a second group of mobile stations with a second performance capability, wherein a mobile station may be assigned and handed over to a timeslot of the frequency hopping radio coverage layer based upon the mobile station's performance capability.

6. The telecommunications network of claim 5, wherein a first group of timeslots within the frequency hopping radio coverage layer is assigned a higher fractional load than a second group of timeslots within the frequency hopping radio coverage layer, and mobile stations are assigned to the first and second groups based on mobile station interference cancellation capability.

7. The telecommunications network of claim 5, wherein the performance characteristic is an interference cancellation capability.

8. The telecommunications network of claim 7, wherein the interference cancellation capability is a single antenna interference cancellation capability.

9. A base transceiver station comprising:
at least one radio transceiver units configurable to support a pseudo-random frequency hopping layer with timeslots having a plurality of fractional loads, and capable of assignment and handover of mobile stations to the pseudo-random frequency hopping layer on a timeslot basis.

10. A radio transceiver unit comprising:
radio circuitry configurable to support frequency hopping; and
timeslots configurable to support a plurality of fractional loads.

11. A method of assigning a mobile terminal to a network comprising:
determining a performance capability of the mobile terminal; and
assigning a timeslot to the mobile terminal based upon the performance capability.

12. The method of claim 11, wherein the performance capability is an interference cancellation capability.

13. The method of claim 12, wherein the interference cancellation capability is a single antenna interference cancellation capability.

14. The method of claim 12, wherein assigning a timeslot to the mobile terminal further comprises assigning a high fractional load timeslot if the mobile terminal has an interference cancellation capability, and assigning a low fractional load timeslot if the mobile terminal does not have an interference cancellation capability.

15. The method of claim 11, wherein determining the performance capability further comprises determining a classmark of the mobile terminal.

16. The method of claim 11, wherein determining the performance capability further comprises measuring a performance parameter of the mobile terminal and determining the performance capability from the performance parameter.

17. The method of claim 11, wherein determining the performance capability further comprises accessing a database and determining the performance capability from a record of the database.

18. A method of assigning a mobile station to a timeslot comprising:
determining that a handover of the mobile station should occur;
determining whether the mobile station supports interference cancellation capability;
handing over the mobile station to low fractional load timeslot if the mobile station does not support interference cancellation; and
handing over the mobile station to a high fractional load timeslot if the mobile station supports interference cancellation.
